(19) United States
(12) Patent Application Publication
(10) Pub. No.: US 2012/0018281 A1
(43) Pub. Date: Jan. 26, 2012

(54) CONVEYOR BELT WITH ARTICULATING TRANSPORT SURFACE

(76) Inventors: Stephen A. McCormick, Warrington, PA (US); Robert Muscato, Monmouth Junction, NJ (US); Michael D. Newman, Hillsborough, NJ (US)

(21) Appl. No.: 12/840,522

(22) Filed: Jul. 21, 2010

(51) Int. Cl. B65G 17/30; B65G 17/06

(52) U.S. Cl. 198/493; 198/853

(57) ABSTRACT

A product support surface for a conveyor belt includes a pair of side links spaced apart by a rod connected therebetween; and a longitudinal member attached to the rod between the pair of side links, the longitudinal member having a surface to support a product thereon during a conveying mode and to be pivoted with respect to the pair of side links during a cleaning mode.

The present embodiments relate to conveyor belts used for transporting products, such as food products, for processing, such as for example chilling, freezing or heating.

### BRIEF DESCRIPTION OF THE DRAWINGS

For a more complete understanding of the present embodiments, reference may be had to the following drawing figures taken in conjunction with the description of the embodiments, of which:

FIG. 1 shows a top perspective view of a portion of a conveyor belt embodiment in the operation mode;

FIG. 2 shows a top perspective view of a product support surface for the conveyor belt embodiment of FIG. 1;

FIG. 3 shows a side view of the conveyor belt embodiment taken along III-III of FIG. 1;

FIG. 4 shows a top perspective view of the product support surface of the conveyor belt embodiment of FIG. 1 disposed for a cleaning mode;

FIG. 5 shows a top perspective view of the conveyor belt embodiment of FIG. 1 in a cleaning mode;

FIG. 6 shows a side view of the conveyor belt embodiment taken along VI-VI of FIG. 5; and

FIG. 7 shows a top plan view of the conveyor belt embodiment of FIG. 5.

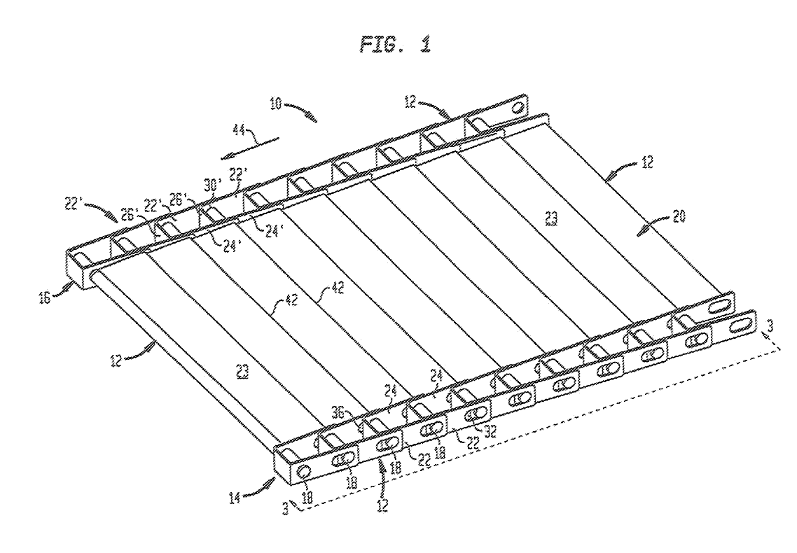

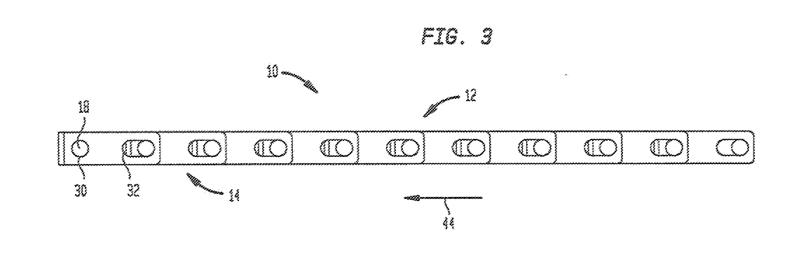

Referring to FIGS. 1-3, portions of a conveyor belt embodiment are shown generally at 10, which consists of a plurality of conveying members or segments shown generally at 12 which articulate with respect to each other. The conveyor belt 10 shown in FIGS. 1-3 has the conveying members 12 disposed in a processing or transport mode. The conveyor belt 10 may be used with for example spiral refrigeration systems.

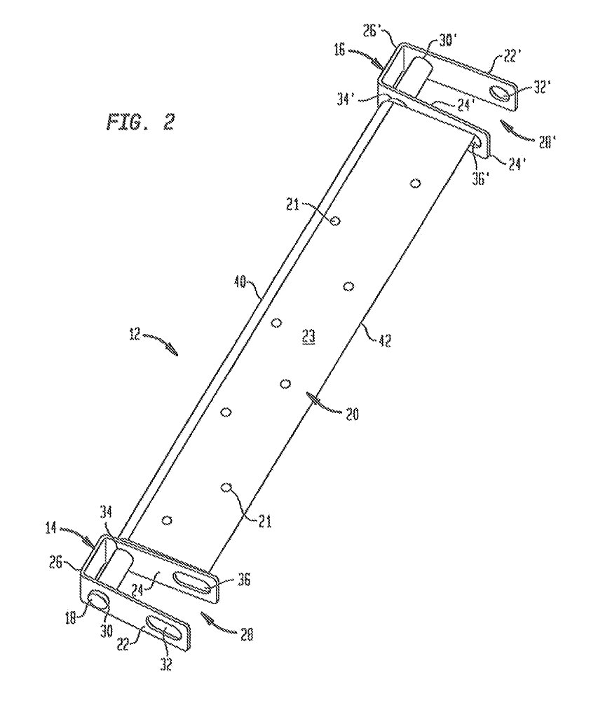

Referring in particular to FIG. 2, each one of the conveying members 12 includes a pair of opposed side links 14,16, a rod 18, and a product support member 20 attached to the rod 18. The product support member 20 includes a support surface 23 upon which the product is carried. The rod 18 and the product support member 20 may be constructed as an integral unit. The product support member 20, or the rod 18 and support member 20 formed as an integral unit, are pivotable with respect to the side links 14,16.

Referring to FIGS. 1 and 2, each of the side links 14,16 is substantially U-shaped, i.e. each one of the side links has a pair of arms which are interconnected by a base portion. The side link 14 has a pair of arms 22,24 which are interconnected by a base portion 26. As shown more clearly in FIG. 2, a space 28 is provided between each of the arms 22,24 for a purpose to be described hereinafter. Each of the arms 22,24 is provided with a pair of holes or slots, i.e. the arm 22 is provided with holes 30,32, while the arm 24 is provided with a pair of holes 34,36. The holes 30,34, each being in opposed arms 22,24, respectively, are in registration with each other; while the holes 32,36, each being in opposed arms 22,24, respectively, are oblong-shaped and in registration with each other, for such reason as will be described hereinafter. The space 28 is larger where the side link 14 opens proximate the holes 32,36, the space 28 tapering to a lesser diameter toward the holes 30,34. This is so that the space 28 can receive the base portion 26 of an adjacent side link 14 as shown for example in FIG. 1.

The side link 16 has a pair of arms 22′,24′ which are interconnected by a base portion 26′. As shown more clearly in FIG. 2, a space 28′ is provided between each of the arms 22′,24′ for a purpose to be described hereinafter. Each of the arms 22′,24′ is provided with a pair of holes or slots, i.e. the arm 22′ is provided with holes 30′,32′, while the arm 24′ is provided with a pair of holes 34′,36′. The holes 30′,34′, each being in opposed arms 22′,24′, respectively, are in registration with each other; while the holes 32′,36′, each being in opposed arms 22′,24′, respectively, are in registration with each other, for such reason as will be described hereinafter. The space 28′ is larger where the side link 16 opens proximate the holes 32′,36′, the space 28′ tapering to a lesser diameter toward the holes 30′,34′. This is so that the space 28′ can receive the base portion 26′ of an adjacent side link 16 as shown for example in FIG. 1.

The rod 18 has opposed ends, each of which is associated with a corresponding one of the side links 14,16. One end of the rod 18 is connected to the side link 14 by extending through the holes 30,34, while an opposed end of the rod 18 is connected to the side link 16 by extending through the holes 30′,34′. Still referring to FIG. 2, an adjacent one of the conveying members 12 is nested and coupled to the adjacent one of the conveying members 12, then another rod 18 has one of its ends extending through the holes 32,36 while an opposed end of that rod 18 extends through the holes 32′,36′. Because a base portion 26,26′of a side link 14,16 would be received in the space 28, 28′ of an adjacent side link, that rod 18 would also have its first end extending through the holes 30,34 of the side links of the adjacent conveying member while the opposed end of the rod 18 would also extend through the holes 30′,34′ of the adjacent conveying member 12. See for example FIG. 1. The construction and arrangement of the holes 32,36 and 32′,36′ enable the conveyor belt 10 to initiated a turn or curve such as when used with spiral conveyors. Alternatively, the holes 32,36 and 32′,36′ may also be circular in shape (similar to the shape of the holes 30,34 and 30′,34′) if the conveyor belt 10 will be moved along a straight line, often referred to as a straight conveyor, and then perhaps turned around a drum (not shown).

Each one of the product support members 20 resembles a substantially flat blade or longitudinal member. A leading edge 40 of the support member 20 is fastened to the rod 18 between two opposed side links 14, 16 as shown for example in FIG. 2. The leading edge 40 may be fastened chemically or mechanically to the rod 18 by epoxy, welding, crimping, pressure fit, etc. Alternatively, the rod 18 and support member 20 may be constructed as an integral unit. An opposed edge 42, the trailing edge, of the support member 20 remains free, i.e. not attached or fastened to any other element. A length of the support member 20 between the side links 14, 16 is at a tolerance so that movement of the support member 20 would not cause it to detrimentally scrape or rub against the arm 24,24′. In other words, the support member 20 must be able to pivot with respect to the side links 14,16. A width of the support member 20 is sufficient so that when the support member 20 is in the transport mode the trailing edge 42 rests upon or contacts, but is not attached to, the leading edge 40 of an adjacent one of the support members 20.

Referring to FIG. 2, it can be seen that when the conveyor belt 10 is in the transporting mode the plurality of support members 20, each has an edge 42 resting upon the edge 40 of an adjacent one of the support members 20. This provides for a smooth transporting surface of the conveyor belt 10. The conveyor belt 10 moves in the direction of arrow 44 as shown in the FIGS.

The product support member 20 may be manufactured from steel or other materials.

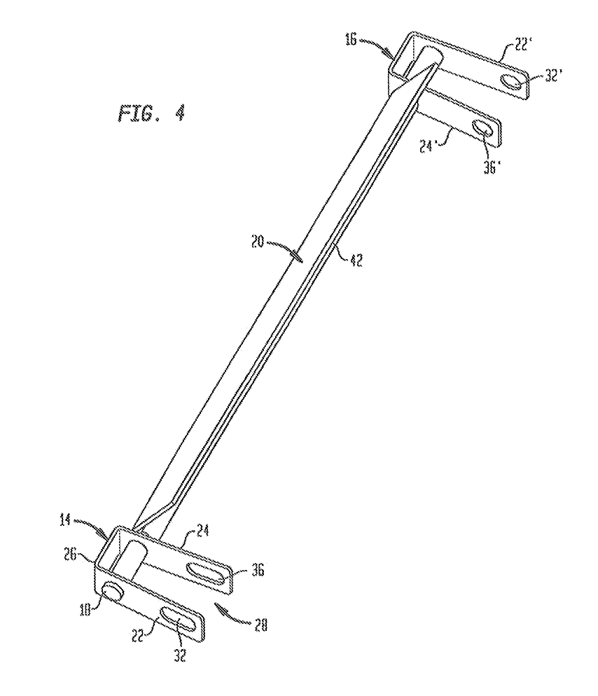

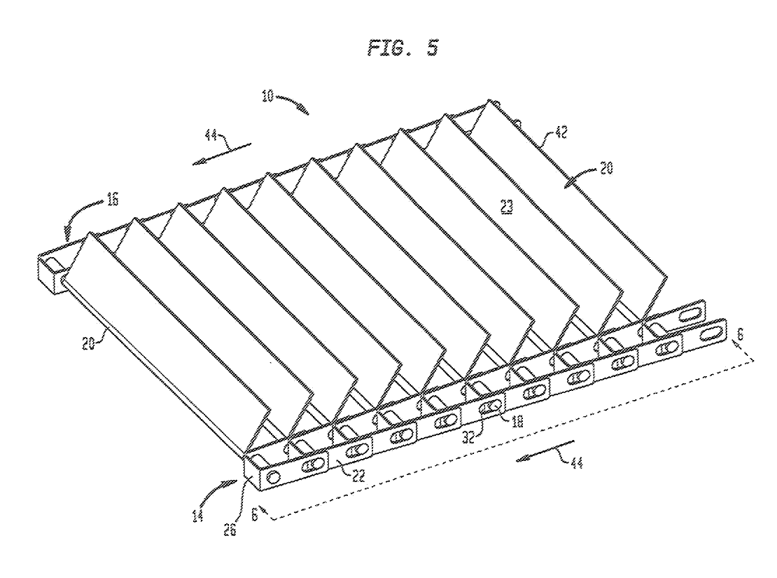

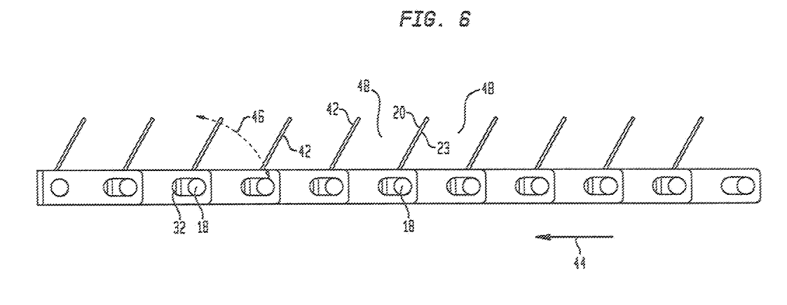

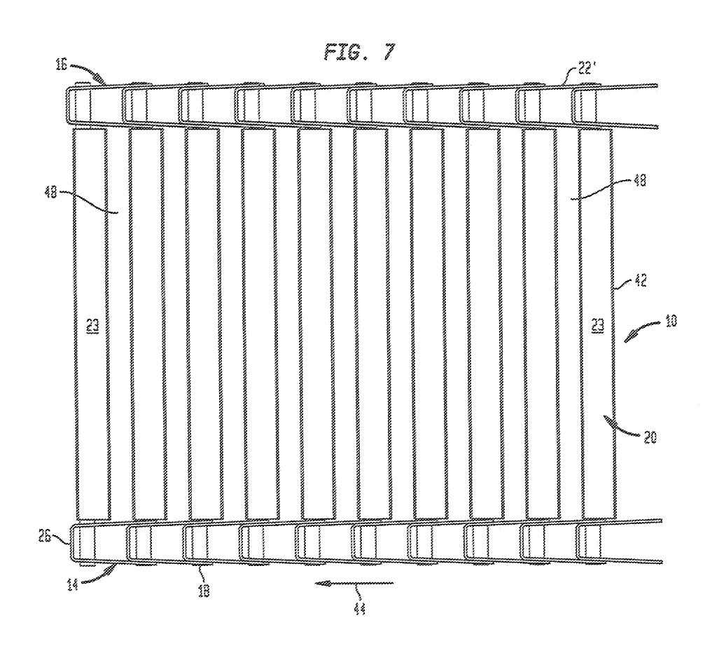

Referring to FIGS. 4-7, the conveyor belt 10 and product support member 20 are shown in a cleaning mode. Cleaning of the conveyor belt 10 can occur while the belt is stationary or while moving for example in the direction of the arrow 44. In the cleaning mode, one or more of the product support surfaces 20 are displaced or pivoted to an upright position, whereby increased space and clearance is provided between the support members 20, as shown in particular in FIGS. 6 and 7. Such spacing and clearance is shown generally at 48. Each one of the product support members 20 can be pivoted upright from the horizontal to as much as 90° from the horizontal, i.e. the support member 20 can be pivoted through an angle or arc 46 where it is perpendicular to the direction of travel of the conveyor belt 10. As shown in particular in FIG. 7, the increased space 48 between the support members 20 provides for a more thorough and effective cleaning, by washing, rinsing or sterilization, of the support members 20, including the surfaces 23, and the pins 18 where displaced product, such as food product that is transported by the conveyor belt 10, is likely to be contained or hidden.

The support members 20 can be displaced by different assemblies or mechanisms (not shown) which can include assemblies which coact with, such as rotate, the rods 18 to which the support members 20 are attached. In addition, flexibility of the side links 14,16 and the “play” between adjacent side links when assembled into the conveyor belt 10 permit the conveyor belt 10 to be displaced along different planes of travel such as for example when the conveyor belt is inverted so that under the effect of the gravity the support members 20 are displaced to the open position for the cleaning mode.

The pairs of holes 30,32 and 34,36 can also be constructed in an oblong as oppose to circular shape so that there is added “play” for the rod 18 in the corresponding holes for the conveyor belt 10 to execute a tighter turn along the same plane of travel.

The support members 20 may be fabricated from stainless steel or plastics. The rods 18 and side links 14, 16 may be manufactured from stainless steel or other materials. At least one support member 20 in an alternative embodiment may have a plurality of holes 21 extending therethrough to increase heat transfer between a cooling medium used to contact the product upon the support surface 23, as shown in FIG. 2.

During operations where the conveyer belt 10 makes a turn through a spiral track for example, such that a return length of the conveyor belt is in a similar or different plane of travel, the oblong-shaped holes 32,36 permit linear movement of adjacent ones of the side links 14, which move or collapse upon the rods 18 at an interior of the spiral turn; while the holes 32′,36′ restrict the side links 16 from pivoting at the outside arc of the turn. When only the side links 14 of the conveyor belt 10 are permitted to move in this manner, the belt 10 will “fan out” to conform to a curve or spiral along a path of travel for the belt.

The product support members 20 and the conveyor belt 10 embodiments can be used with food and pharmaceutical products for example.

It will be understood that the embodiments described herein are merely exemplary, and that one skilled in the art may make variations and modifications without departing from the spirit and scope of the invention. All such variations and modifications are intended to be included within the scope of the invention as described and claimed herein. Further, all embodiments disclosed are not necessarily in the alternative, as various embodiments of the invention may be combined to provide the desired result.

What is claimed is:

1. A product support surface for a conveyor belt, comprising:
a pair of side links spaced apart by a rod connected therebetween; and
a longitudinal member attached to the rod between the pair of side links, the longitudinal member comprising a surface to support a product thereon during a conveying mode and to be pivoted with respect to the pair of side links during a cleaning mode.

2. The product support surface of claim 1, wherein the longitudinal member is mechanically fastened to the rod and the rod is rotatable to pivot the longitudinal member with respect to the pair of side links.

3. The product support surface of claim 1, wherein the longitudinal member is mechanically fastened to the rod and the longitudinal member is rotatable with respect to the rod such that the longitudinal member may be pivoted with respect to the pair of side links.

4. The product support surface of claim 1, wherein the rod and the longitudinal member are constructed as an integral unit.

5. The product support surface of claim 1, wherein each side link of the pair of side links comprises at least one hole for receiving a corresponding end of the rod.

6. The product support surface of claim 1, wherein the longitudinal member is pivotable up to 90° with respect to the pair of side links.

7. The product support surface of claim 1, wherein each side link of the pair of side links has an open end into which a portion of another side link from another pair of side links can be received for coaction therewith.

8. The product support surface of claim 1, wherein the longitudinal member is substantially flat and comprises a leading longitudinal edge attached to the rod and a trailing longitudinal edge for contacting another leading longitudinal edge of an adjacent longitudinal member.

9. The product support surface of claim 1, wherein the longitudinal member comprises a plurality of holes extending therethrough.

10. The product support surface of claim 1, wherein the pair of side links and longitudinal member are constructed from materials selected from metal, plastic, and a combination of same.

11. A conveyor belt, comprising a plurality of the product support surfaces of claim 1 arranged adjacent to for coaction with each other.

12. A conveyor belt, comprising:
a first plurality of side links arranged in a first row;
a second plurality of side links arranged in a second row spaced apart from the first row;
a plurality of rods interconnecting the first and second rows, each rod from the plurality of rods interconnecting a side link from the first row with a corresponding side link from the second row being in registration therewith; and
a plurality of longitudinal members each having a support surface for transporting a product thereon, each one of the longitudinal members attached to a corresponding one of the plurality of rods and moveable between a conveying position wherein the plurality of longitudinal members are aligned horizontally with each other between the first and second plurality of side links, and a cleaning position wherein the plurality of longitudinal members are pivoted with respect to the first and second plurality of side links.

13. The conveyor belt of claim 12, wherein the plurality of rods are rotatable for pivoting the plurality of longitudinal members between horizontal and vertical positions.

14. The conveyor belt of claim 12, wherein the plurality of longitudinal members are pivotable up to 90° with respect to the first and second plurality of side links.

15. The conveyor belt of claim 12, wherein each side link of the first and second plurality of side links has an open end into which a portion of another side link from the corresponding first and second plurality of side links can be received for coaction therewith.

16. The conveyor belt of claim 12, wherein at least one of the plurality of longitudinal members comprises a plurality of holes extending therethrough.
